(19) United States
(12) Patent Application Publication
(10) Pub. No.: US 2018/0355948 A1
(43) Pub. Date: Dec. 13, 2018

(54) DRAIN PLUG MASS DAMPER

(71) Applicant: FORD GLOBAL TECHNOLOGIES, LLC, Dearborn, MI (US)

(72) Inventors: Kenneth MALONE, Troy, MI (US); Robert REINERS, Grosse Ile, MI (US); Sara E. VEYO, Canton, MI (US); Hariharan GANESAN, Farmington Hills, MI (US)

(21) Appl. No.: 15/620,392

(22) Filed: Jun. 12, 2017

(51) Int. Cl. F16F 15/02; B62D 25/24; B62D 27/06; B62D 33/023

(52) U.S. Cl. CPC F16F 15/02; B62D 25/24; B62D 27/065; B60Y 2306/09; F16F 2228/04; F16F 2230/0005; B62D 33/023

(57) ABSTRACT

A truck bed of a vehicle includes a sheet metal panel defining a drain opening, a mass damper plug disposed within the opening and including a mass casting having a predefined mass configured to tune a frequency of a sound wave of the panel and plug into a predefined range, and defining bolt threads, and a bolt engaged with the bolt threads and configured to secure the plug with the panel.

### TECHNICAL FIELD

The present disclosure relates to mass damper assemblies for automotive vehicles.

### BACKGROUND

Vehicle components, such as an engine, may produce noise or vibration signals during normal operation. For example, a vehicle component may have moving elements or sub-components which produce noise or vibration signals having a predefined frequency. These vibrations may be received or detected by a passenger in a vehicle cabin.

### SUMMARY

A truck bed of a vehicle includes a sheet metal panel defining a drain opening, a mass damper plug disposed within the opening and including a mass casting having a predefined mass configured to tune a frequency of a sound wave of the panel and plug into a predefined range, and defining bolt threads, and a bolt engaged with the bolt threads and configured to secure the plug with the panel.

A truck bed of a vehicle includes a sheet metal panel defining a drain opening, a mass damper plug disposed within the opening and including a mass casting having a predefined mass configured to tune a frequency of vibration of the panel and plug to exclude a predefined range, and a bolt engaged with the plug and configured to secure the plug with the panel.

A truck bed of a vehicle includes a sheet metal panel defining a drain opening, a mass damper plug disposed within the opening and including a mass casting having a predefined mass configured to alter a frequency of a noise vibration and harshness (NVH) sound wave of the panel and plug to exclude second- and third-order frequencies, and a retention cap configured to engage the plug through the opening to secure the plug about the panel to seal the opening.

### BRIEF DESCRIPTION OF THE DRAWINGS

FIG. 1 is a perspective view of a vehicle body;

FIG. 2 is a perspective view of a water management system of a cargo bed portion;

FIG. 3 is a perspective view of the water management system of a tonneau cover;

FIGS. 4A-4B are perspective views of example drain plug assemblies for a vehicle;

FIGS. 5A-5B are perspective views of an example drain plug mass damper; and

FIGS. 6A-6D are cross-section views of the drain plug mass damper.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Sound may be defined as a change in pressure within air, water, or another medium that can be detected by a human ear. Noise is an unwanted sound that may be hazardous to health, interfere with speech and verbal communications or is otherwise disturbing, irritating, or annoying. Amplitude and frequency characteristics of a given sound or noise may be helpful in analyzing and modifying or eliminating it.

Components of automotive vehicles may output vibrations or noise during operation. For example, vehicle combustion engines or other components may produce second- and/or third-order broadband frequency vibrations generated by mechanical components in the engine. These frequencies may pass through the air, or via vehicle components, into a passenger compartment of the vehicle resulting in an undesired sound pressure on a driver or a passenger's ear. Further, since the engine is attached to a vehicle body structure, these vibrations may excite structural systems of the vehicle body structure. This energy excitement may generate structure-borne noise which results in sound pressure changes or noise in the passenger compartment causing occupant disturbance or dissatisfaction.

A mass damper plug may be disposed within an opening defined by a vibrating sheet metal panel to seal the opening and tune frequency of the sound or vibration. In one example, the plug may comprise a body configured to tune frequency of a sound wave of the plug and panel defining the opening into one or more predefined frequency ranges or frequency bands. Additionally or alternatively, the body of the mass damper plug may comprise a predefined mass configured to moderate, minimize, block, or exclude one or more frequencies or frequency bands of a sound wave of the plug and panel defining the opening.

As one example, the body of the mass damper plug may comprise a predefined mass configured to tune frequency of a sound or vibration wave of the plug and panel defining the opening into a range corresponding to engine speed. As another example, the body of the mass damper plug may comprise a predefined mass configured to moderate, minimize, block, or exclude at least one of a second- and third-order frequencies or frequency bands of a sound wave of the mass damper plug and panel defining the opening. As still another example, the mass damper plug may comprise a predefined mass configured to tune frequency of a sound or vibration wave to a value equal to or falling within a range between 25 Hz and 30 Hz. As yet another example, the mass damper plug may comprise a predefined mass configured to moderate, minimize, block, or exclude frequencies or frequency bands of a sound wave of the mass damper plug and panel that are equal to or fall within a range between 50 Hz and 60 Hz and/or equal to or fall within a range between 75 Hz and 90 Hz.

An amplitude of a sound wave, or height of the wave from peak to valley, may determine the loudness or intensity of the sound. A length of the sound wave, i.e., wavelength, may determine frequency, pitch or tone of the sound. The frequency of sound may be expressed in wavelengths per second or cycles per second, commonly referred to as Hertz. Low frequency noise may be defined as noise having frequency equal to or less than 250 Hertz (Hz) and high frequency noise may be defined as noise having frequency equal to or greater than 2 kHz. Mid-range frequency noise may be defined as noise having a frequency value that falls between that of the high and low frequency noise. Amplitude of a given sound wave may be expressed in decibels (dB), or a logarithmic compressed scale using powers of 10 increments such that small changes in dB may correspond to large changes in acoustic energy.

Sound wavelength may define a linear measurement of one complete cycle of displacement during which motion of air molecules is first compressed and then rarefied, or expanded. In some cases, the wavelength of a sound wave may be determined using a ratio of a speed of sound with respect to frequency.

The frequency range for audio acoustics may extend from about 20 Hz to 20 kHz. An ultrasonic region, an acoustic region to which an average human ear may be totally insensitive, may encompass frequencies higher than 20 kHz. Vibration signals may include signals having frequencies as low as 0.1 Hz. Noise and vibration signals may be analyzed in terms of their respective frequency components. A pure tone of sound may include a simple harmonic pressure fluctuation of constant frequency and amplitude, whereas a complex harmonic wave may include several frequency components which could be either harmonically or non-harmonically related, and a random noise signal may include either a broadband or a narrowband frequency spectrum. Thus, individual noise and vibration signals may be one of complex signals, deterministic signals, or random signals, and may be analyzed within frequency bands.

Octave bands may be standardized frequency bands used for frequency analysis and may define groups of frequencies such that an upper frequency value of a given band is twice a lower frequency value of that band. Using the octave bands, performance of different acoustical materials may, thereby, be compared with one another. Equipment noise levels and measurement devices (dB meters) further may conform with one or more predefined octave bands. As one example, 1 kHz may be a center frequency of an octave band and may define a reference frequency. Respective center frequencies of other octave bands may, thus, be defined with respect to the reference frequency, such as by, beginning with the reference frequency, identifying each one of subsequent center frequencies by multiplying or dividing a center frequency that immediately precedes it by 10 3/10 (a factor of two). Upper and lower boundaries of each octave band may be obtained by multiplying or dividing, respectively, the computed center frequencies by 10 3/20 (a factor of √2), such that an upper boundary frequency value of a given octave band may correspond to twice a respective lower boundary frequency value of the octave band.

Frequency bandwidths such as octave and one-third-octave bands are constant percentage bandwidths since the bandwidth is always a constant percentage of the center frequency. Thus, frequency bandwidths may increase with frequency. Both octave and one-third octave band analyses may be adequate when the amplitudes of the frequency components within the various bands are relatively constant (broadband noise). Broadband noise has a frequency spectrum or signature where there are no discreet or dominant tones. Sound pressure fluctuations of broadband noise are non-periodic in nature with relatively random phase and amplitude. Although devoid of discrete frequencies, the acoustical energy of broadband noise may, nevertheless, be concentrated in one or more areas of a given spectrum. Examples of broadband noise include noise generated by one of shop air blow-offs, gas fired burners, jet engines, and grinding tools.

A narrow bandwidth analysis, e.g., one-third octave band analysis, may be applied when certain frequencies within a given octave band dominate over others. The narrow bandwidth analysis may include defining a bandwidth such that a constant frequency occurs throughout that bandwidth. Tonal noise is commonly referred to as discrete frequency noise and is characterized by spectral tones having “pure tone” characteristics, or sound waveforms that occur at a single frequency. Tonal noise may be generated by rotating components and may be characterized by a predefined frequency relating to the rotational speed of the shaft and the number of compressor vanes, fan blades, engine pistons, gear teeth, etc.

The fundamental tone (F) may also manifest itself at progressively lower intensity levels at integer harmonic multiples (2F, 3F, etc.). Tolerance levels for tonal noise may generally be at a lower threshold. Spectral data measured using frequency filter sets may be necessary to assess tonal content. Characterizing the source noise frequencies in full octave bands may not provide the degree of spectral definition of fractional one-third octave bandwidths and discernable tones shown in one-third octave format may not be apparent in a full octave analysis. In these instances, a narrow band frequency analysis may be used to identify one or more different tones. Examples of tonal noise may include, but are not limited to, noise generated by fans, rotary lobe blowers, compressors, gears, transformers, saws, and piston driven engines. Furthermore, noise control strategies for tonal noise sources may be directed to discrete frequencies.

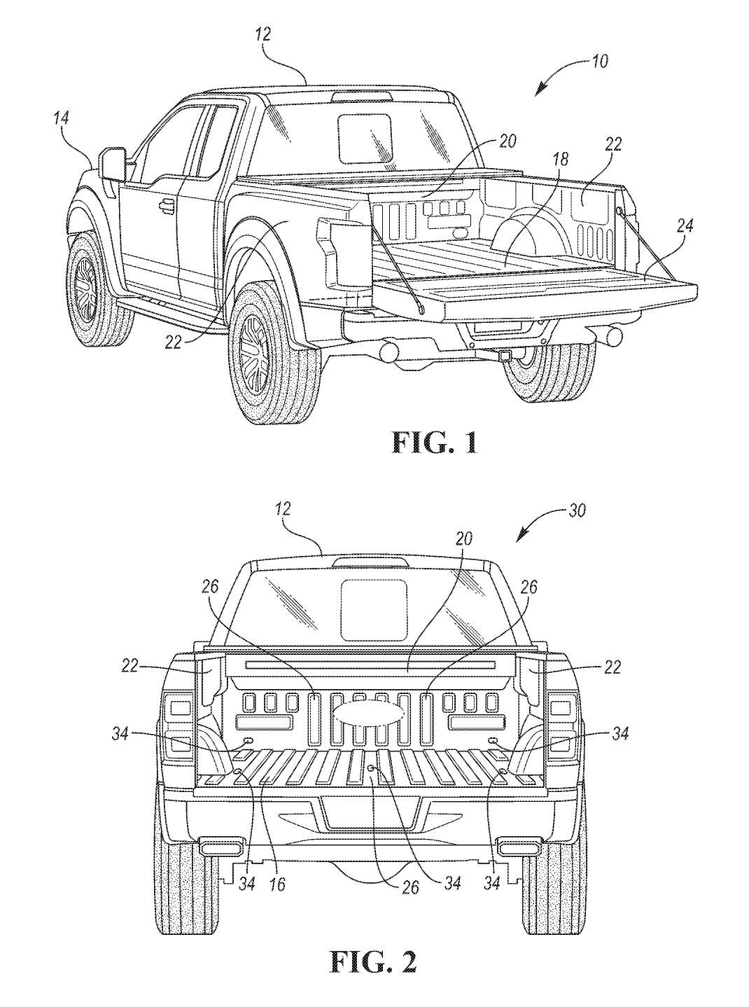

FIG. 1 illustrates an example of a portion of a vehicle body, referred to generally as a vehicle body 10 herein. The vehicle body 10 includes a cabin portion 12, an engine compartment portion 14, and a cargo bed portion 16, wherein the portions 12, 14, and 16 are interconnected via a chassis and/or a vehicle frame (not shown). The engine compartment portion 14 may house an engine, such as via one or more engine mounts (not shown) that secure the engine to one or more engine compartment rails (not shown).

As one example, the cargo bed portion 16 may define a base panel 18, a front panel 20, one or more side panels 22, and a rear panel 24. The front, side, and rear panels 20, 22, and 24 may be disposed about outer edges of the base panel 18, thus, forming an open-top cargo bed having inner and outer portions. The front, side, and rear panels 20, 22, and 24 may be further secured relative to one another and relative to the base panel 18 using one or more front and rear sills and/or cross-members (not shown). The panels 18, 20, 22, and 24 may each comprise one or more sheet metal portions having predetermined thickness (or gauge) and formed, e.g., using stamping process operations, to define a plurality of channels 26 configured to increase rigidity of the respective panel, accommodate cargo separation, and so on. In one example, the sheet metal portions may define steel, aluminum, or another substance, material, a metal or non-metal alloy, as well as, one or more other combinations and compositions.

As illustrated in FIG. 2, one or more portions of the cargo bed portion 16 may further define a water management system 30 comprising a plurality of dispensing features, e.g., water channels 32, drain openings 34, and so on. The dispensing features may be configured to direct, isolate, and/or drain water, moisture, debris, and other matter from one or more areas of the cargo bed portion 16. The dispensing features of the water management system 30 may, thereby, be configured to lessen, minimize, or prevent water, moisture, debris, and other matter from collecting in one or more areas of the cargo bed portion 16. One or more of the drain openings 34 may be configured to receive a respective drain opening cover (hereinafter, drain opening plug) 36. When disposed within the respective drain opening 34, the drain opening plug 36 may be configured to seal the drain opening 34 and prevent passage of components, elements, materials and so on to and from the cargo bed portion 16 via the drain opening 34. The drain opening plug 36 may be selectively removable to enable water, moisture, debris, and other matter to drain or exit one or more areas of the cargo bed portion 16.

Custom improvements or modifications to the vehicle body 10 may include additions to or modification of one or more portions of the vehicle body 10, including additions to or modification of the cargo bed portion 16. As some examples, custom modifications to the cargo bed portion 16 may include installing one or more toolboxes, storage cases and/or bags, as illustrated, for instance, by element 36 of FIG. 1, drop-in or spray-in cargo bed liners, tonneau covers, and so on.

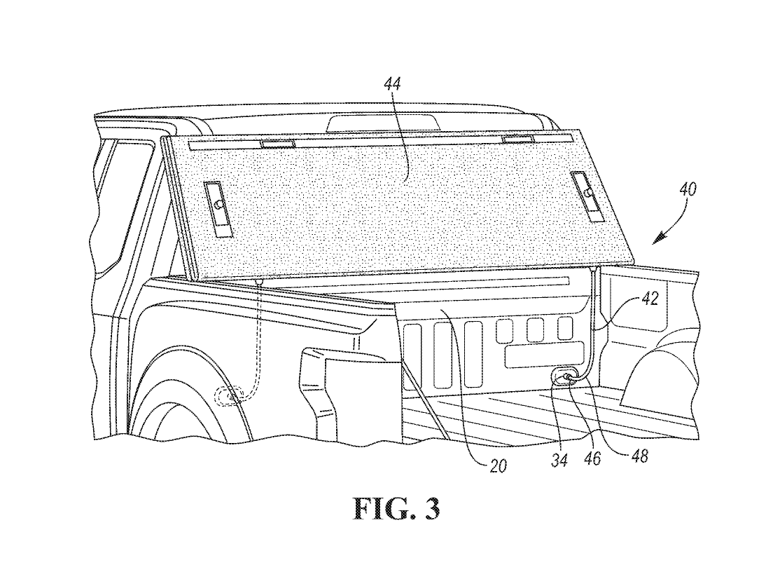

FIG. 3 illustrates an example water management system implementation 40 for a tonneau cover 44 disposed about outer edges of the front, side, and rear panels 20, 22, and 24, respectively, opposite the base panel 18. The system 40 may include a hose 42 connected with a tonneau cover 44 at a first end 46 and connected with the drain opening 34 at a second end 48. In some instances, the first end 46 of the hose 42 may be connected about a periphery of a first aperture defined by the tonneau cover 44 and the second end 48 of the hose 42 may be connected about a periphery of a second aperture defined by the drain opening plug 36, such that the second end 48 is aligned to dispense matter through the drain opening 34 when the drain opening plug 36 is disposed within the drain opening 34.

The hose 42 of the water management system 40 may, thereby, be configured to selectively direct (or drain) water, moisture, debris, or other matter entering the first aperture away from one or more areas of the cargo bed portion 16 or adjacent components, e.g., from the outer portion of the tonneau cover 44, and toward the drain opening 34. As one example, the tonneau cover 44 may be configured to define a first closed position impeding or inhibiting access to the inner portion of the cargo bed portion 16 and a second open position enabling or easing access to the inner portion of the cargo bed portion 16. The hose 42 may, thereby, be configured to direct water, moisture, debris, or other matter disposed about outer portion of the tonneau cover 44 toward the drain opening 34 when the tonneau cover 44 is placed in the second open position.

While the system 40 illustrates using one or more drain openings 34 to direct matter disposed about an outer portion of the tonneau cover 44, the use of the drain openings 34 is not so limited. Other implementations for using the drain openings 34 and other draining features of the water management system 40 are also contemplated. For example, one or more of the drain openings 34 may be used during sheet metal processing, painting, or another manufacturing, testing, or finishing operation.

As one non-limiting example, electro coating process, e.g., e-coating, electrophoretic deposition (EPD), cathodic electrodeposition, electrophoretic coating, or electrophoretic painting, may define a sheet metal panel finishing process that includes wholly or partially submerging the panel into wet paint and using electric current to attract (or deposit) the paint onto the surface of the submerged portion of the panel. The panel carrying electric charge that is opposite in polarity to that of the paint particles suspended in paint may cause the particles to adhere to the submerged portion of the panel. The process may result in a low-profile film being formed over the surface of the panel, wherein the thickness of the film may be defined by a magnitude of the applied voltage differential.

During one or more processing, testing, and/or finishing operations, the drain openings 34 of a given sheet metal panel may permit material to pass between one or more surfaces of the panel, thereby, balancing or otherwise affecting relative pressure or temperature of the surfaces and so on. As one non-limiting example, the drain openings 34 of a panel being submerged in wet paint during e-coating, by permitting enveloping material to pass quicker or more uniformly between various surfaces, may shorten an amount of time (or decrease an amount of force) used to complete the operation, further ensure uniformity of the paint coat, and so on.

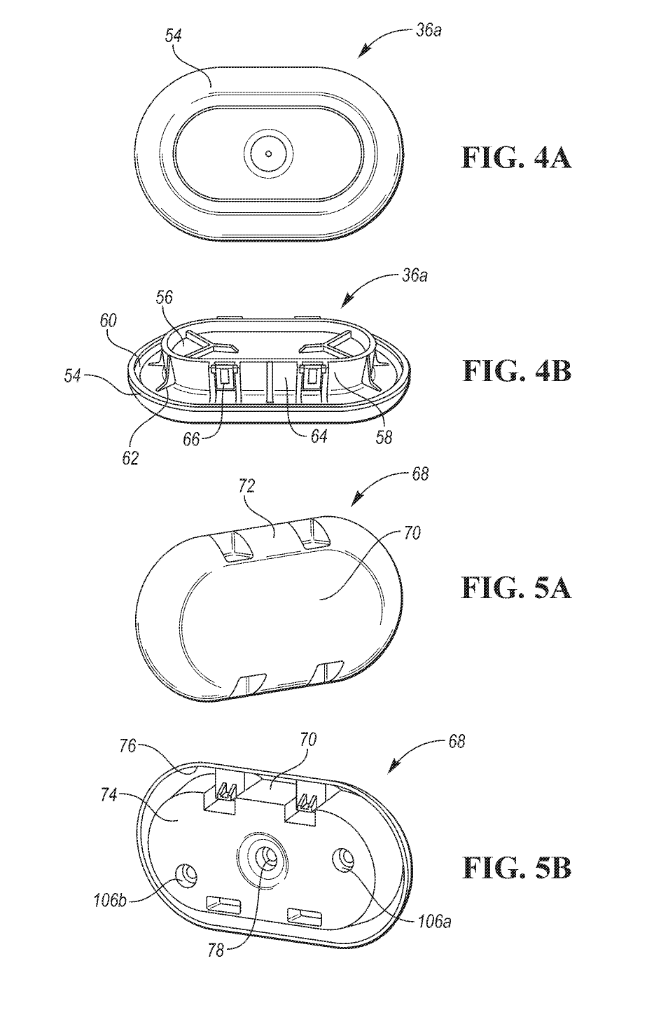

FIGS. 4A-4B illustrate perspective views of an example drain opening plug 36a configured to be removably disposed within one or more of the drain openings 34, such as the drain openings 34 described in reference to at least FIG. 2. The drain opening plug 36a may comprise a predefined material shaped using one or more material-processing methods, techniques, and machinery, such as, but not limited to, bending, pressing, rolling, molding, casting, cutting, and permanent or semi-permanent joining. As one example, the drain opening plug 36a may comprise plastic shaped using at least one of blow molding, computer numerical control (CNC) machining, centrifugal casting, continuous strip molding, compression molding, profile extrusion, continuous lamination, injection molding, filament winding, thermoforming, vacuum forming, pressure bag molding, pressure forming, pulshaping, twin sheet forming, pultrusion, liquid resin molding, reaction injection molding (RIM), rotational molding, and resin transfer molding (RTM). As another example, the drain opening plug 36a may comprise a natural or synthetic rubber compound shaped using at least one of compression molding, transfer molding, and injection molding. As some other examples, the drain opening plug 36a may comprise material or substance including, but not limited to, wood, metal, glass, and petroleum products, shaped using corresponding manufacturing techniques such as to be removably disposed within one or more of the drain openings 34.

The drain opening plug 36a may define a cap portion 54, e.g., illustrated in FIG. 4A, and a base portion 56, e.g., illustrated in FIG. 4B, disposed opposite of the cap portion 54. The base portion 56 of the drain opening plug 36a may define a raised portion 58 extending outward from a center of the base portion 56 to define a flange 60 that extends from a periphery of the base portion 56 to the raised portion 58. The raised portion 58 may be selectively disposed within the drain opening 34 and may be sized to fit snuggly therein such as to seal the drain opening 34. As one example, the raised portion 58 may include a plurality of ridges 62 configured to engage the periphery of the drain opening 34, such that outer walls 64 of the raised portion 58 fit tightly therein.

The outer walls 64 of the raised portion 58 may define a plurality of flexible clips 66 configured to selectively secure the drain opening plug 36a to the cargo bed portion 16 when the drain opening plug 36a is disposed within the drain opening 34. As one example, the flexible clips 66 may be configured to compress inwardly and toward a center of the raised portion 58 such that the raised portion 58 may be inserted within the drain opening 34. The flexible clips 66 may be configured to release outwardly to brace the drain opening plug 36a against the cargo bed portion 16 when the drain opening plug 36a is disposed to seal the drain opening 34. Forcible pull of the flexible clips 66 engaging the outer surface of the cargo bed portion 16 may be opposed or countered by a force of the flange 60 engaging the inner surface of the cargo bed portion 16, thereby, firmly securing the drain opening plug 36a to seal the drain opening 34.

FIGS. 5A-5B illustrate perspective views of an example mass damper plug 68 configured to be removably disposed within one or more of the drain openings 34, such as the drain openings 34 described in reference to at least FIG. 2. As one example, the mass damper plug 68 comprises a predefined mass configured to put/tune frequency of a sound wave of the panel and plug into one or more predefined frequency ranges or frequency bands. As another example, the mass damper plug 68 comprises a predefined mass configured to temper, minimize, block, or exclude one or more frequencies or frequency bands of a sound wave occurring at the mass damper plug 68 and panel defining the drain opening 34, e.g., the base, front, side, rear panel 18, 20, 22, 24, respectively, and so on.

Vibration emitting sources including, but not limited to, the engine, moving components of the engine, and a vehicle suspension system, may emit vibration energy that may be further transferred to a vehicle body structure, including the cabin portion 12, the cargo bed portion 16, and so on. Examples of the moving components of the engine that may produce undesirable noise and/or vibration sound waveforms perceivable by a vehicle occupant include, but are not limited to, timing chains, gears, valves, bearings, and an air induction system.

Source and nature of the noise and vibration waveforms may be determined based on a change over time in operational behavior of a moving component. As one example, rotating or reciprocating components of a vehicle may produce varying magnitudes of noise and vibration disturbances at different rotational speeds. An order analysis of the sound waveforms may enable separating desirable sounds from noise and vibration signals, as well as, pinpointing physical elements or components of the mechanical system from which a given waveform originates.

The order analysis, or order-based analysis, may include, but is not limited to, order tracking, order extraction, and tachometer signal processing. Thus, noise and vibration signals received via one or more sensors, microphones, accelerometers, displacement probes, or tachometers positioned in proximity with the vehicle may then be analyzed in a relevant coordinate system or reference scale, e.g., Bode, polar, shaft centerline, orbit, and timebase plots, decibel (dB) reference scale, and so on. An order of a noise and vibration waveform may be based on a rotational speed, or a certain multiple of the rotational speed, of a given component. Thus, a vibration signal with a frequency equal to twice, or two times, the rotational frequency of a motor corresponds to an order of two, e.g., second-order, and a vibration signal that has a frequency equal to 0.5 times the rotational frequency of the motor corresponds to an order of 0.5, e.g., half-order. Different orders in a sound or vibration signal may, for example, be identified using a spectral map or an order power spectrum layout. Furthermore, one or more orders of the signal may be extracted for further analysis, such as analysis of a combination of orders of the signal and so on.

The mass damper plug 68 may comprise a body 70 defining an outer portion 72 and a raised inner portion 74 and configured to tune frequency of a sound wave of the plug and panel defining the drain opening 34, e.g., the base, front, side, rear panel 18, 20, 22, 24, respectively, and so on, into one or more predefined frequency ranges or frequency bands. As one example, the body 70 of the mass damper plug 68 may comprise a predefined mass configured to tune frequency of a sound or vibration wave of the plug and panel defining the drain opening 34 into a range corresponding to engine speed. As another example, the mass damper plug 68 may comprise a predefined mass configured to tune frequency of a sound or vibration wave to a value equal to or falling within a range between 25 Hz and 30 Hz.

The body 70 of the mass damper plug 68 may comprise a predefined mass configured to moderate, minimize, block, or exclude one or more frequencies or frequency bands of a sound wave of the mass damper plug 68 and panel defining the drain opening 34. As one example, the body 70 of the mass damper plug 68 may comprise a predefined mass configured to moderate, minimize, block, or exclude at least one of a second- and third-order frequencies or frequency bands of a sound wave of the mass damper plug 68 and panel defining the drain opening 34. As another example, the mass damper plug 68 may comprise a predefined mass configured to moderate, minimize, block, or exclude frequencies or frequency bands of a sound wave of the mass damper plug 68 and panel 80 that are equal to or fall within a range between 50 Hz and 60 Hz and/or equal to or fall within a range between 75 Hz and 90 Hz.

As one example, the outer portion 72 may be dome-shaped to extend over the raised inner portion 74 such as to form a cap over a top of the raised inner portion 74. The raised inner portion 74 may be sized to be selectively disposed within the drain opening 34. The raised inner portion 74 may, for instance, be sized to fit tightly within the drain opening 34 to securely seal the drain opening 34 when disposed therein. Outer periphery of the outer portion 72 may extend substantially beyond outer periphery of the raised inner portion 74 to define a skirt 76. The raised inner portion 74 may also define a raised portion opening 78 sized to receive a fastener 88 therethrough, wherein the fastener 88 defines a shank 98 and a head 100 disposed at a first end of the shank 98 and having a diameter that is larger than a diameter of the shank 98.

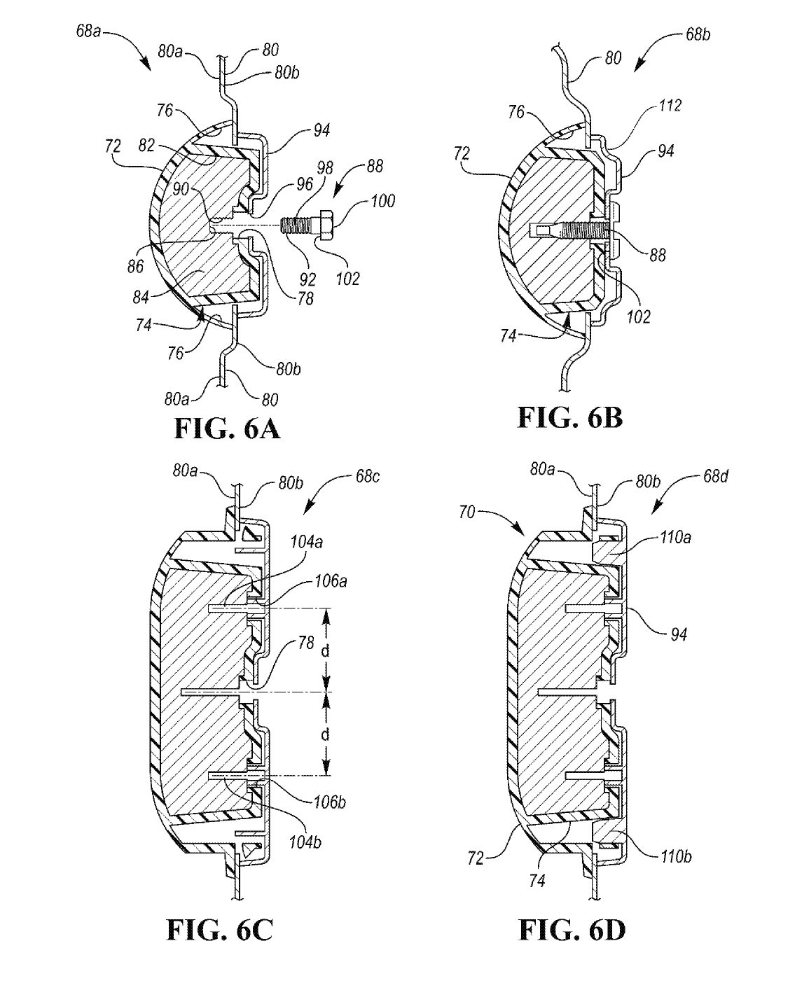

FIG. 6A illustrates a cross-section view of the mass damper plug 68a configured to be removably disposed within at least one drain opening 34 defined by a sheet metal panel 80, such as, for example, by one of the base, front, side, and rear panels 18, 20, 22, and 24 of the cargo bed portion 16. The sheet metal panel 80 may define an inner surface 80a defining the inner surface of the cargo bed portion 16 and an outer surface 80b defining the outer surface of the cargo bed portion 16. In one example, the drain opening 34 may be disposed substantially within the channel 26 defined by the cargo bed portion 16, as described, for instance, in reference to FIG. 2.

The outer portion 72 and the raised inner portion 74 of the mass damper plug 68a may define a cavity 82 configured to receive a mass casting 84 therein. As one example, one or more portions of the body 70 of the mass damper plug 68a, such as the outer portion 72 and the raised inner portion 74, may comprise a molded shell defining a pocket configured to receive the mass casting 84 therein. The molded shell may comprise nylon, plastic, or another pliable, ductile, and/or moldable material that may be formed or shaped using one or more material-processing techniques. The body 70 of the mass damper plug 68a may be configured to selectively engage the inner surface 80a of the sheet metal panel 80. For example, the skirt 76 defined by the outer portion 72 of the body 70 may be configured to engage the inner surface 80a substantially about outer periphery of the drain opening 34 defined by the sheet metal panel 80.

The mass casting 84 may comprise a metal or nonmetal material having a predefined mass configured to tune frequency of a sound wave of the panel 80 and plug 68a into one or more predefined frequency ranges or frequency bands. The mass casting 84 may define material including one or more of pure metal, metal alloy, carbon fiber or another carbon product, natural or synthetic polymer, and so on. As one example, the mass casting 84 may comprise a predefined mass configured to tune frequency of a sound or vibration wave of the plug and panel defining the drain opening 34 into a range corresponding to engine speed. As another example, the mass casting 84 may comprise a predefined mass configured to tune frequency of a sound or vibration wave to a value equal to or falling within a range between 25 Hz and 30 Hz.

The mass casting 84 may comprise a predefined mass configured to moderate, minimize, block, or exclude one or more frequencies or frequency bands of a sound wave of the mass damper plug 68a and the panel 80 defining the drain opening 34. As one example, the mass casting 84 may comprise a predefined mass configured to moderate, minimize, block, or exclude at least one of a second- and third-order frequencies or frequency bands of a sound wave of the mass damper plug 68 and panel defining the drain opening 34. As another example, the mass casting 84 may comprise a predefined mass configured to moderate, minimize, block, or exclude frequencies or frequency bands of a sound wave of the mass damper plug 68 and panel 80 that are equal to or fall within a range between 50 Hz and 60 Hz and/or equal to or fall within a range between 75 Hz and 90 Hz.

The mass casting 84 may define a depression 86, e.g., an annular or square depression, disposed such that the depression 86 may be aligned with the raised portion opening 78 along longitudinal axis and sized to receive at least a portion of the shank 98 of the fastener 88 therein. As one example, the depression 86 may be substantially annular or tubular in shape and may define threads 90 corresponding to threads 92 of the fastener 88.

The mass damper plug 68a may include a retention cap 94 defining a cap opening 96. The retention cap 94 may be selectively disposed to engage the outer surface 80b of the panel 80 of the cargo bed portion 16, such that the cap opening 96 may be disposed concentrically with the drain opening 34 to be sealed using the raised inner portion 74 of the mass damper plug 68a. The cap opening 96 of the retention cap 94 may be sized to selectively receive at least a portion of the shank 98 therethrough. In some instances, the cap opening 96 may be sized to be smaller than the head 100 of fastener 88, such that the retention cap 94 defining periphery of the cap opening 96 may selectively engage an underside 102 of the fastener head 100. Thus, the fastener 88 driven into the depression 86 of the mass casting 84 may secure together the retention cap 94 and the body 70 of the mass damper plug 68a about the sheet metal panel 80, wherein the retention cap 94 engages the outer surface 80b of the sheet metal panel 80 and the body 70, e.g., via the skirt 76, engages the inner surface 80a of the sheet metal panel 80.

FIG. 6B illustrates a cross-section view of the mass damper plug 68b configured to be removably disposed within at least one drain opening 34 defined by the sheet metal panel 80 including the inner surface 80a corresponding to the inner surface of the cargo bed portion 16 and the outer surface 80b corresponding to the outer surface of the cargo bed portion 16. One or more indentations 112 formed about a midsection of the retention cap 94 may be configured to increase structural rigidity of the cap 94 with respect to vibration waveforms delivered by the panel 80.

FIGS. 6C-6D illustrate cross-section views of the mass damper plugs 68c and 68d, respectively. The mass casting 84c may define a pair of cavities 104a and 104b disposed diametrically opposite one another about the center of the depression 86 and each offset from the center of the depression 86 by a distance, d. The cavities 104a and 104b may each define thread and may be sized to receive a fastener (not shown) therein, e.g., via corresponding fastener threads. As one example, respective centers of the cavities 104a and 104b may align with those of auxiliary openings 106a and 106b of the raised inner portion 74 configured to receive at least a portion of the fastener therethrough. As illustrated in FIG. 6D, the retention cap 94 may further define retention clips 110a and 110b configured to engage the raised inner portion 74 to secure the retention cap 94 and the body 70 of the mass damper plug 68d about the sheet metal panel 80, wherein the retention cap 94 engages the outer surface 80b of the sheet metal panel 80 and the body, e.g., via the skirt 76, engages the inner surface 80a of the sheet metal panel 80.

The processes, methods, or algorithms disclosed herein may be deliverable to or implemented by a processing device, controller, or computer, which may include any existing programmable electronic control unit or dedicated electronic control unit. Similarly, the processes, methods, or algorithms may be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms may also be implemented in a software executable object. Alternatively, the processes, methods, or algorithms may be embodied in opening or in part using suitable hardware components, such as Application Specific Integrated Circuits (ASICs), Field-Programmable Gate Arrays (FPGAs), state machines, controllers or other hardware components or devices, or a combination of hardware, software and firmware components.

The words used in the specification are words of description rather than limitation, and it is understood that various changes may be made without departing from the spirit and scope of the disclosure. As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A truck bed of a vehicle comprising:
a sheet metal panel defining a drain opening;
a mass damper plug disposed within the opening and including a mass casting
having a predefined mass configured to tune a frequency of a sound wave of the panel and plug into a predefined range, and
defining bolt threads; and
a bolt engaged with the bolt threads and configured to secure the plug with the panel.

2. The bed of claim 1 further comprising a retention cap engaged with the bolt and panel.

3. The bed of claim 2, wherein the retention cap is configured to cover the plug.

4. The bed of claim 1, wherein the plug further includes a shell configured to encase the mass casting and contact the panel.

5. The bed of claim 1 further comprising a retention cap engaged with the bolt and panel, and a shell configured to encase the mass casting and contact the panel, wherein the retention cap and portion of the shell are on opposite sides of the panel.

6. The bed of claim 1, wherein the predefined range excludes at least one of second-order and third-order frequencies defined based on a change in a rotational speed of a component of the vehicle over a predefined period.

7. The bed of claim 6, wherein the excluded frequencies are frequencies between 75 hertz (Hz) and 90 Hz.

8. The bed of claim 1, wherein the panel is at least one of a base, front, side, and rear panel defining periphery of the truck bed.

9. A truck bed of a vehicle comprising:
a sheet metal panel defining a drain opening;
a mass damper plug disposed within the opening and including a mass casting having a predefined mass configured to tune a frequency of the panel and plug into a predefined range; and
a bolt engaged with the plug and configured to secure the plug with the panel.

10. The bed of claim 9 further comprising a retention cap engaged with the bolt and panel.

11. The bed of claim 10, wherein the retention cap is configured to cover the plug.

12. The bed of claim 9, wherein the plug further includes a shell configured to encase the mass casting and contact the panel.

13. The bed of claim 9 further comprising a retention cap engaged with the bolt and panel, and a shell configured to encase the mass casting and contact the panel, wherein the retention cap and portion of the shell are on opposite sides of the panel.

14. The bed of claim 9, wherein the predefined range excludes at least one of second-order and third-order frequencies defined based on a change in a rotational speed of a component of the vehicle over a predefined period.

15. The bed of claim 14, wherein the component is an element of an engine.

16. The bed of claim 14, wherein the excluded frequencies are frequencies between 75 hertz (Hz) and 90 Hz.

17. A truck bed of a vehicle comprising:
a sheet metal panel defining a drain opening;
a mass damper plug disposed within the opening and including a mass casting having a predefined mass configured to alter a frequency of a noise vibration and harshness (NVH) sound wave of the panel and plug to exclude second- and third-order frequencies; and
a retention cap configured to engage the plug through the opening to secure the plug about the panel to seal the opening, wherein the retention cap and the plug are on opposite sides of the panel.

18. The bed of claim 17, wherein the plug further includes a shell configured to encase the mass casting and contact the panel.

19. The bed of claim 17, wherein the second- and third-order frequencies are defined based on a change in a rotational speed of an engine of the vehicle over a predefined period.

20. The bed of claim 19, wherein the second-order frequencies are frequencies between 50 hertz (Hz) and 60 Hz and the third-order frequencies are frequencies between 75 Hz and 90 Hz.
